(19) United States
(12) Patent Application Publication
(10) Pub. No.: US 2009/0063249 A1
(43) Pub. Date: Mar. 5, 2009

(54) Adaptive Ad Server

(75) Inventors: John Anthony Tomlin, Sunnyvale, CA (US); Ralphe Wiggins, Ashland, OR (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/849,811

(22) Filed: Sep. 4, 2007

(51) Int. Cl. G06Q 30/00; G06F 17/30; G06F 17/40

(52) U.S. Cl. 705/10; 705/14

(57) ABSTRACT

A system is disclosed for distributing an ad to a user. The system may include and advertisement database for maintaining a plurality of advertisements, and a user profile database for maintaining a plurality of user profiles. The system may also include an advertisement server coupled with the advertisement database and the user profile database, the advertisement server operable to: receive a first set of information indicative of a user profile; receive a second set of information indicative of an ad property; receive a third set of information indicative of a plurality of advertisements; determine, based on the user profile, a user group for the user, the user group having an associated probability of an action in relation to an advertisement; select, based on the determined user group and the ad property, an advertisement from the plurality of advertisements for placement in the ad property; and deliver the selected advertisement at the ad property to the user.

### BACKGROUND

1. Technical Field

This application relates to advertisement delivery systems. More particularly, this application relates to a flexible system for optimal delivery of various advertisement campaigns to particular users.

2. Related Art

Advertising on the World Wide Web is ubiquitous and a big business. For example, web portals and ISPs may receive a significant amount of revenue that may be generated from displaying advertisers' advertisements, such as banner ads, on their websites or web pages. For example, for a preeminent portal such as Yahoo! which is visited daily by hundreds of thousands, if not millions, of users, considerable revenue can be made by displaying an advertiser's ads on its websites or web pages.

In order to maximize their effects, ads ideally need to be placed in strategic locations, both physically and temporally, for maximum exposure to the targeted audience. Identifying strategic locations, therefore, is critical in planning any advertising efforts. Demographics are often used in the process of determining strategic locations for advertising purposes.

Additionally, like advertising conducted through more traditional media, such as TV or printed publications, advertising on the Internet is similarly subject to physical limitation. There are only a finite number of page views, with associated advertising slots available. These may be sold in two ways. Firstly, they may be sold at a negotiated price to an advertiser, for guaranteed delivery to users who fit the advertisers desired profile. Note that even among such users, there will be considerable variance in the likelihood of receiving a click, because of other factors not explicitly in the advertiser's profile. Secondly, there may be impressions sold by auction for “best effort” but not guaranteed delivery.

For preeminent web portals such Yahoo!, which act as publisher, content provider and advertising medium it may be that in addition to third party advertisers that directly contribute revenue by paying for advertisements, these portals must also determine how to utilize the limited supply while also placing advertisements for internal or “house” businesses that may directly or indirectly contribute revenue in a variety of ways. Thus there may be 3 sources of both revenue and demand for impressions, which should be met in such a way as to maximize revenue, or some other metric, while satisfying the constraints imposed by available inventory and advertiser demand.

### BRIEF SUMMARY

In one embodiment, a method for delivering an advertisement to a user is provided. The method may include: receiving a first set of information indicative of a user profile; receiving a second set of information indicative of an ad property; receiving a third set of information indicative of a plurality of advertisements; determining, based on the user profile, a user group for the user, the user group having an associated probability of an action in relation to an advertisement; selecting, based on the determined user group and the ad property, an advertisement from the plurality of advertisements for placement in the ad property; and delivering the selected advertisement at the ad property to the user.

In another embodiment, a system is disclosed for distributing an ad to a user. The system may include an advertisement database for maintaining a plurality of advertisements, and a user profile database for maintaining a plurality of user profiles. The system may also include an advertisement server coupled with the advertisement database and the user profile database, the advertisement server operable to: receive a first set of information indicative of a user profile; receive a second set of information indicative of an ad property; receive a third set of information indicative of a plurality of advertisements; determine, based on the user profile, a user group for the user, the user group having an associated probability of an action in relation to an advertisement; select, based on the determined user group and the ad property, an advertisement from the plurality of advertisements for placement in the ad property; and deliver the selected advertisement at the ad property to the user.

These and other embodiments and aspects are described with reference to the noted Figures and the below detailed description of the preferred embodiments.

### BRIEF DESCRIPTION OF THE DRAWINGS

FIG. 1 is a diagram of an exemplary architecture for delivering advertisements to users;

FIG. 2 is a diagram of an exemplary web page including advertisements properties;

FIG. 3 is a flow chart of an exemplary method for determining an approximately probability that a user will respond to an advertisement;

FIG. 4 is an exemplary structure for a logistic regression model;

FIG. 5A is an exemplary distribution of user clusters;

FIG. 5B is another exemplary distribution of user clusters

FIG. 6 is a flow chart of an exemplary method for delivering advertisements to a user.

### DETAILED DESCRIPTION

Systems and methods, generally referred to as systems, are disclosed for delivering ads to a user in order to ascertain optimal revenue. Existing technologies may limit the manner in which advertising mediums are able to take advantage of the total available revenue obtainable from a set of ads. The systems described herein may solve some of these problems by allowing a flexible way for optimally distributing a given set of ads so as to extract maximum revenue. Additionally, the ads may be delivered in accordance with additional delivery constraints that ad value to the ad.

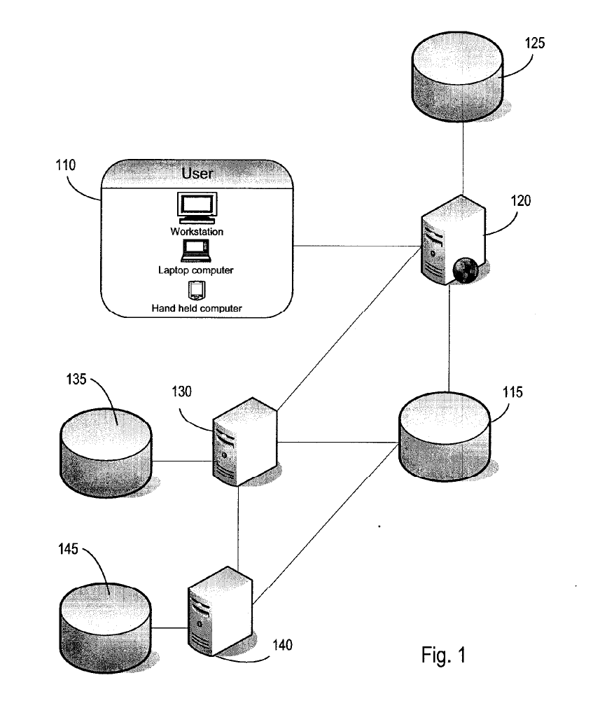

Referring now to the drawings, and initially to FIG. 1, an exemplary architecture 100 may be used for delivering advertisements to a user. The architecture 100 may include a user client system 110, a user profile database 115, a web server 120, a content database 125, an ad server 130, an ad database 135, a historical data analysis server 140, and a historical data database 145. Although reference is now made to specific components of the system performing specific features, it should be apparent that such reference is exemplary, is not intended to limit the scope of the claims in any way, and that the functionalities described herein may be implemented in a virtually unlimited number of configurations.

The user client system 110 may request content such as web pages or the like that include properties for advertisements from the content server 120 via a communications network. The communication network may be any private or public communication network. For example, the user client system 110 may connect to the content server 120 via the Internet using a standard browser application. A browser based implementation allows system features to be accessible regardless of the underlying platform of the user client system 110. For example, the user client system 110 may be a workstation computer, laptop computer, handheld computer, cell phone, mobile messaging device, or the like which may all utilize different hardware and/or software packages. Alternatively, or additionally, the user client system 110 may connect to the content server 120 using a stand-alone application which may be either platform dependent or platform independent. Other methods may be used to implement the user client system 110.

The content server 120 may receive the request for content from the user client system 110. For example, the content server may be a web server that delivers a web page that includes one or more properties for inclusion of an ad. The content may be stored in the content database 125. Other content that may be delivered with an advertisement, such as video-on-demand, may also be used. The content server 120 may also be in communication with the user profile information database 115, and may store and/or obtain information relating to the user from the database 115. User 110 information may be tracked in a variety of ways. For example, each user 110 may be represented by a variety of cookies, such as a P cookie, a L cookie, a B cookie, and a Space ID. The B cookie may provide identification information about the user's particular browser. The P cookie may provide demographic information, such as age, sex, occupation, and the like about a user. The L cookie may provide a user name of a user. Finally, the Space ID may provide identification information about the web page for which the record is generated. The user 110 information may include current known information associated with the user, such as an IP address, country, state, DMA, demographic information, behavioral information, known interests, age (or age group), gender, and the like. Other information about the user 110 may also be maintained.

The content server 120 may receive the request from the user 110 and communicate information indicative of the user client 110 and the advertisement properties associated with the desired content to the ad server 130. In response, the ad server 130 may select an ad to be shown in the advertisement properties of the content based on the user information. The ad server 130 may be in communication with the ad database 135, which may store information relating to advertisements. The ad server 130 may also be in communication with the user profile information database 115, and may obtain additional information relating to the user from the database 115. The ad server 130 may receive information relating to the likelihood that a particular user group may respond to an ad from the historical data analysis server 140. The ad server 130 may receive user information and ad property information from the content server 120, determine a user group for the requesting user, and select an ad for inclusion at each ad property based on the determined the user group. Optionally, the ad server 130 may also employ additional constraints that affect the delivery of a given ad, as described below.

The historical data analysis server 140 may analyze historical data, stored on the historical information database 145, relating to user's activities relating to ads. For example, the historical data may include user's 110 click-through rate and/or conversion rate for all ads shown to the user 110. Alternatively, or additionally, the historical data may be tracked for on daily, weekly, or monthly periods. Other intervals may also be used. The historical data analysis server 140 may determine the likelihood that a particular user group will respond to a given ad, as described below.

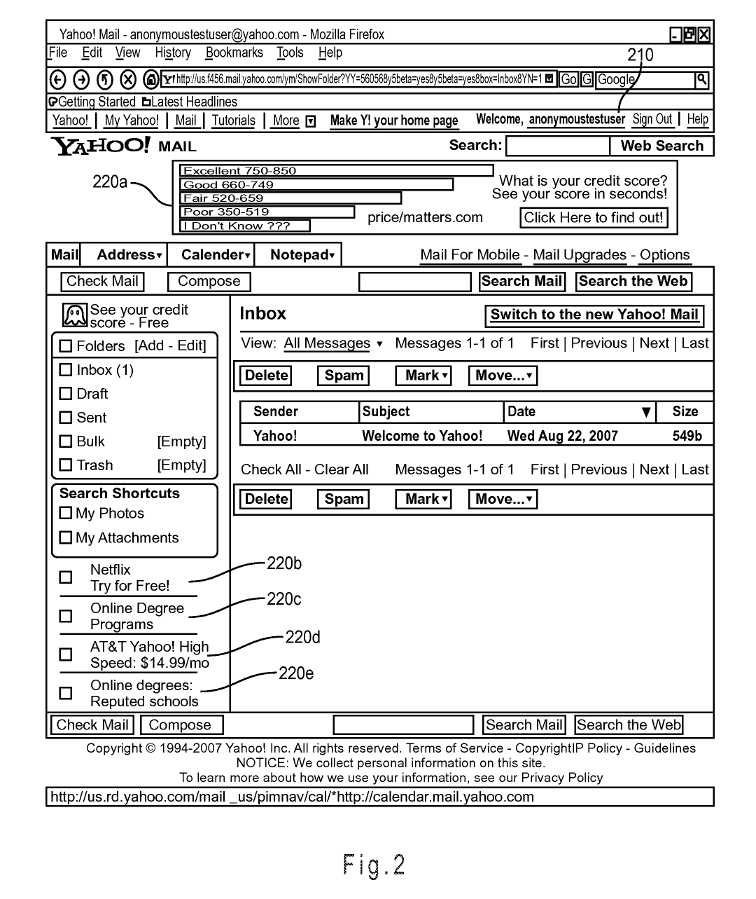

FIG. 2 is a diagram of exemplary content that includes an ad property/position. In the example of FIG. 2, the content is a web page 200 may include one or more ad properties 220a, 220b, 220c, 220d, and 220e. Each property 220a, 220b, 220c, 220d, and 220e may be occupied by an ad that is delivered to the user in accordance with an ad contract. Contracts may cover ad campaigns. As used herein, the term ad campaign refers to a group of ads, any one of which may be delivered to a user 210 to satisfy a delivery under the contract. The ad campaign may include any of the following information: a budget, beginning and end dates, a set of ads, a set of desired or required properties/positions, and a number of desired impressions, clicks, or conversions. Optionally, campaign profile limits including properties and targeting, such as hour-of-week, gender, age, geographical constraints, and the like.

Generally, the advertisers pay a fee for each ad viewed by web users. For example, ads may be sold on a per-impression, per-click, or per-action basis. Other types of ads may also be sold. Contracts to show ads are normally signed several weeks/months before ads get delivered. The duration of contracts ranges from one day to multiple years. Typically, there are several types of contracts, including regular contracts, exclusive contracts and infinite contracts. For regular contracts, the advertisers purchase a designated number of ad views on a chosen space (web page). For exclusive contracts, they purchase all the ad views on a chosen space. For infinite contracts, they purchase all the leftover ad views on a chosen space after other regular contracts related to that space have been fulfilled. Regular and exclusive contracts may also be referred to as class 1 ads, and may be sold for a negotiated price to advertisers on a guaranteed basis. In other words, the ad space (inventory) purchased is guaranteed to be available. Infinite contracts may also be referred to as Class 2 ads, which may be sold by auction, and shown on a “best effort” basis. The Class 2 ads may be further divided into “house” ads, which may be purchased by the web portal for its own use, and the remainder, which may be bought by outside advertisers.

For a preeminent web portal such as Yahoo!, house businesses may include such services as Email, Personals, and the like. These house businesses may contribute to gross income in 3 ways. Under a first revenue type, businesses that sell a product or service, such as Small Business and Personals, may contribute directly to income. For these types of house businesses, benefits for the competition with paying clients for inventory resources may be based on net income minus life time revenue reduced by an estimate of the cost of the business.

Under a second revenue type, businesses that may enhance traffic by encouraging users to go to other parts of the portal may also contribute to revenue. To the extent that the cost of the clicked-on ads is less than the income on the target property, the net income attributable to these types of businesses may the difference between these two amounts and such ads may compete in the optimization on that basis. In a dynamic environment, both the cost and income may be tracked to take advantage of current ad effectiveness and user behavior. This may help to reduce the effects of ad fatigue, whereby ads may become less effective the more times they are viewed. Finally, under a third revenue type, there may be house businesses that enhance income simply by increasing the overall appeal of the portal's network. While the evaluation of such “appeal” may not be easily quantitative, total traffic on each property and a value per user may be used to estimate the value of these businesses. Other methods for estimating the revenue generated by house ads may also be used. Ads of other revenue types may also be used.

In theory, so long as house businesses can profitably compete for ads under revenue types 1 or 2, and all other things being equal, the house business may have unlimited budgets since portal revenue should increase with additional spending. However, in reality budgets are not unlimited, and other factors, such as ad fatigue and the need to deliver the guaranteed Class 1 ads, may limit such Class 2 spending.

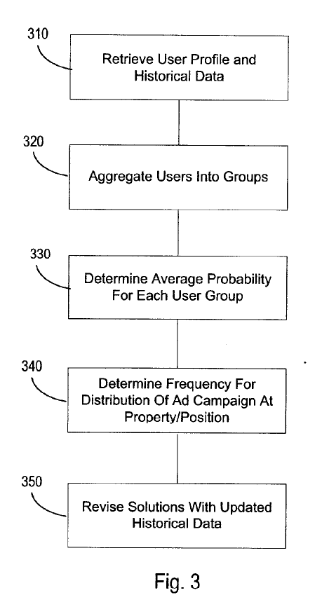

FIG. 3 is a flow chart of an exemplary method for determining an approximate probability that a user will respond to an advertisement. Initially, user information and historical data relating to user responsiveness to ads may be retrieved at 310. The user information may include a bit-vector representative of known user information, as described above. The bit-vector may store complex information, such as a user's 110 country or region using a hierarchy of bits. The historical data may include counts representative of a user's 110 responsiveness to ads, such as counts representative of the number of clicks, conversions, and the like for the user 110, as described above. This information may be tracked for each property/position and for each ad campaign.

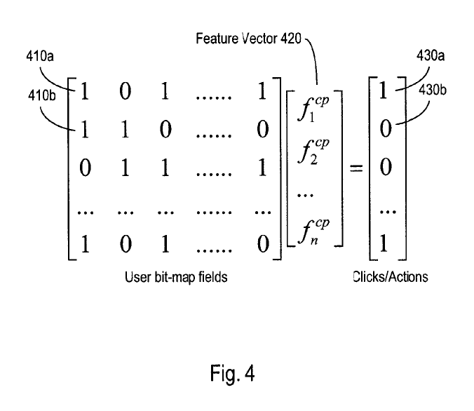

The historical information may be inserted into a logistic regression model, such as the logistic regression model depicted in FIG. 4. For example, bit-vectors 410a and 410b for each user (or cookie or other tracking mechanism) and their associated click counts 430a and 430b may be inserted into a logistic regression model. The solutions of the model may provide a “feature vector” 420 that may be used to estimate the likelihood that a given user (as defined by a particular bit-vector) will respond to an ad.

Returning to FIG. 3, the users 110 may be aggregated into groups of like users 110 at 320 once the feature vector 420 has been determined. The users 110 may be grouped using any method. For example, users 110 having a similar likelihood of responding to a given ad campaign at a given property may be grouped. The determined feature vector 420 for a given campaign may be used to determine the likelihood that each user 110 will respond to the given ad campaign. The inner product of the feature vector 420 and a given user's bit-vector 410a may provide an estimate of the probability of a click for that user. Once the probability of a click for each user 110 is determined, the users may be segmented into groups. Once segmented, the average probability of a click for each user group may be calculated at 330.

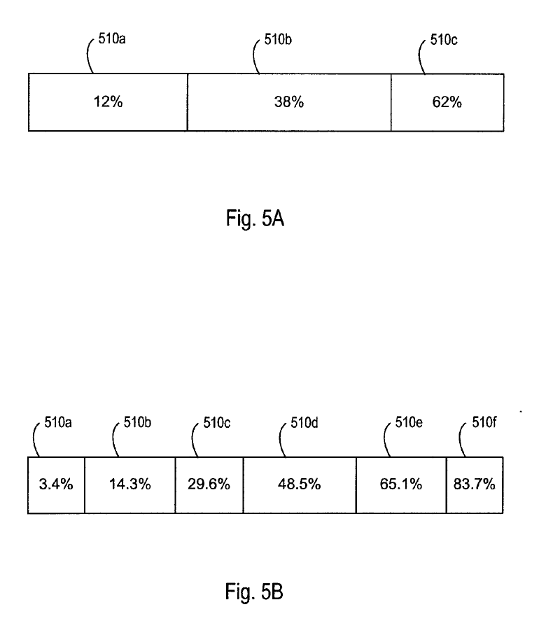

Exemplary user groups and their associated average probabilities are depicted in FIGS. 5A and 5B. For example, FIG. 5A shows a set of three users groups, such as a “low” 510a, “medium” 510b, and “high” 510c. Each group 510a, 510b, and 510c may have an associated average probability, such as 12%, 38%, and 62% as shown in FIG. 5A. Similarly, user groups may be grouped into additional groups, such as shown in FIG. 5B.

Next, a linear programming model may be solved to determine the frequency that each ad campaign at a particular property/position should be shown to each user group at 340. The linear programming model may attempt to minimize the unspent budget for all types of ad campaigns. The linear programming model may also estimating the revenue of house businesses using any of the three revenue models described above, and attempt to maximize the total revenue derived from both house business and third party ads. An exemplary linear programming model including a frequency (x_{crp}) defined as the total number of impression to show to a particular user group for a given ad campaign at a property/position may be defined as set forth in Table 1.0. Optionally, the frequency may be normalized by the total expected impression volume for the property/position (Vₚ) to determine the probability that an ad from the given campaign at a given property position to a user belonging to the given user group.

TABLE 1.0
Exemplary Linear Programming Model

Indices
c = 1, . . . , C Campaigns
r = 1, . . . , R_{c} Click-Frequency buckets for Campaign c
p = 1, . . . , PP Property/Positions
S_{c} Set of Property/Positions associated with Campaign c
Data

| | |
|---|---|
| B_{c} | Budget for Campaign c |
| A_{cr} | Probability of an action for CPA Campaign c given a click by a |
| | user in bucket r. |
| P_{crp} | Probability of a click when Campaign c is shown on |
| | Property/Position p to user in bucket r. |
| Vₚ | Available impressions at Property/Position p. |
| I_{Mc} | Income/impression for Campaign c |
| I_{Cc} | Income/click for Campaign c |
| I_{Ac} | Income/acquisition for Campaign c |
| I_{YAc} | Net Income/acquisition less cost of doing business for House |
| | Campaign c |
| I_{YCc} | Net arbitrage income from driving traffic to another Web portal |
| | property for House Campaign c |
| I_{YMc} | Value of enhancing the appeal (and traffic) by acquainting users |
| | with other parts of the Web portal network for house |
| | Campaign c |
| α | Weight for comparing House and Client income |

Variables

| | |
|---|---|
| x_{crp} | Number of impressions to show for Campaign c, Frequency |
| | bucket r, Property/Position p |
| y_{Mc} | Unspent budget for CPI Campaign c (i.e. explicit slack) |
| y_{Cc} | Unspent budget for CPC Campaign c (i.e. explicit slack) |
| y_{Ac} | Unspent budget for CPA Campaign c (i.e. explicit slack) |
| y_{MCc} | Unspent budget for House enhancing Campaign c (i.e. explicit |
| | slack) |

Constraints

| | |
|---|---|
| ${\sum }_{cr} {x}_{crp} \leq {V}_{p}$ | Impression constraint |
| ${\sum }_{rp} {I}_{YCc} {x}_{crp} + {y}_{YMc} = {B}_{c}$ | CPI Campaign Budgets |
| ${\sum }_{rp} {P}_{crp} {I}_{Cc} {x}_{crp} + {y}_{C c} = {B}_{c}$ | CPC Campaigns Budgets |
| ${\sum }_{rp} {A}_{cr} {P}_{crp} {I}_{Ac} {x}_{crp} + {y}_{A c} = {B}_{c}$ | CPA Campaigns Budgets |
| ${\sum }_{rp} {I}_{YMc} {x}_{crp} + {y}_{YMc} = {B}_{c}$ | CPI Enhancement Campaign Budgets |

Objective
Min Σ_{c} y_{Mc} + Σ_{c} y_{Cc} + Σ_{c} y_{Ac} + Σ_{c} y_{YMc} − α Σ_{c}/_{YCc} P_{crp} x_{crp}

The historical data for each campaign and property position may be updated at regular intervals and a new set of solutions may be obtained at 350. As a result, the linear programming model may quickly adapt to changes in user activity, such as click-through rates and the like. For example, historical data may be updated every 15 minutes, hour, or daily. Other intervals may also be used. Using shorter intervals allows even new ad campaigns to be quickly tuned and productive within a short time of its launch.

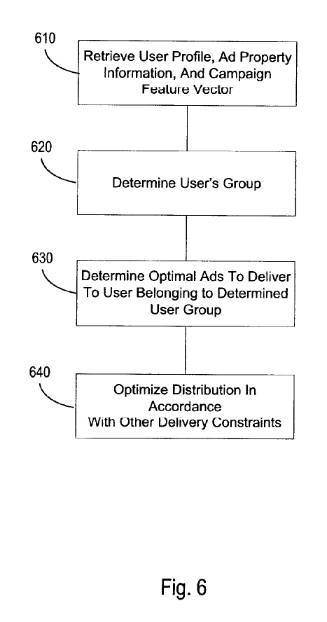

FIG. 6 is a flow chart of an exemplary method for delivering advertisements to a user. Initially, user profile, ad property and campaign feature vector information may be retrieved at 610. For example, the ad server 130 may retrieve user profile information from the user profile database 115, ad campaign feature vector information may be provided by the historical analysis server 140, and the ad property information may be provided by the content server 110. Next, the group for the user defined by the retrieved user profile information is determined at 620. For example, the user group may be determined by calculating the inner product of a bit-vector associated with the user and a feature vector indicative of the characteristics associated with a higher probability of a click or action, as determined by the logistic regression. An ad may then be selected in accordance with a determined frequency associated with an ad campaign at the given property for a user belonging to the determined user group at 630.

Finally, the distribution of impression allocations may be optimized based on additional delivery constraints at 640. For example, the remaining time and budget for a given ad campaign may be taken into account to ensure that the terms of a campaign contract is fulfilled. Additionally, or alternatively, a maximum catch-up rate may be imposed to ameliorate spikes in delivery. For example, a maximum catch-up rate of twice the uniform delivery rate may be imposed

It is therefore intended that the foregoing detailed description be regarded as illustrative rather than limiting, and that it be understood that it is the following claims, including all equivalents, that are intended to define the spirit and scope of this invention.

1. A method for delivering an advertisement to a user, comprising:
receiving a first set of information indicative of a user profile;
receiving a second set of information indicative of an ad property;
receiving a third set of information indicative of a plurality of advertisements;
determining, based on the user profile, a user group for the user, the user group having an associated probability of an action in relation to an advertisement;
selecting, based on the determined user group and the ad property, an advertisement from the plurality of advertisements for placement in the ad property; and
delivering the selected advertisement at the ad property to the user.

2. The method of claim 1, where the plurality of advertisements include third party advertisements and house business advertisements.

3. The method of claim 2, where the selected advertisement is selected, in part, based on an expected revenue generated by at least one house business advertisement.

4. The method of claim 1, where the action is one selected from the group comprising a click, a conversion, or any combination thereof.

5. The method of claim 1, further comprising determining the average probability associated with the user group.

6. The method of claim 5, where the determining the average probability includes:
maintaining user profile information for each of a plurality of users, the user profile information including a bit vector;
solving a logistic regression model based on the bit vectors of user profile information and historical advertisement related activities for the user;
determining, for each user profile of a plurality of user profiles, the inner product of the logistic regression solution and each of the user profiles;
segmenting the plurality of users into user groups; and
determining an average probability for each of the user groups in accordance with the determined inner products.

7. The method of claim 6, further comprising:
determining, by solving a linear programming model based on the determined average probabilities, a distribution for the plurality of ads.

8. The method of claim 7, where the distribution is determined based on a constraint selected from the group comprising a temporal constraint, a geographic constraint, or any combination thereof.

9. The method of claim 1, further comprising determining an optimal user group for the ad property.

10. The method of claim 1, further comprising limiting the maximum delivery of the selected advertisement in a period of time.

11. A system for distributing an ad to a user, comprising:
an advertisement database to maintain a plurality of advertisements;
a user profile database to maintain a plurality of user profiles;
an advertisement server coupled with the advertisement database and the user profile database, the advertisement server operable to:
receive a first set of information indicative of a user profile;
receive a second set of information indicative of an ad property;
receive a third set of information indicative of a plurality of advertisements;
determine, based on the user profile, a user group for the user, the user group having an associated probability of an action in relation to an advertisement;
select, based on the determined user group and the ad property, an advertisement from the plurality of advertisements for placement in the ad property; and
deliver the selected advertisement at the ad property to the user.

12. The system of claim 11, where the plurality of advertisements include third party advertisements and house business advertisements.

13. The system of claim 12, where the selected advertisement is selected, in part based on an expected revenue generated by at least one house business advertisement.

14. The system of claim 11, where the action is one selected from the group comprising a click, a conversion, or any combination thereof.

15. The system of claim 11, further comprising a historical data analysis server coupled with the user profile database, the historical data analysis server operable to determine the average probability associated with the user group.

16. The system of claim 15, where the user profile database maintains user profile information for each of a plurality of users, the user profile information including a bit vector,
the system further comprising a historical data database for maintaining historical advertisement related activities for the users, where the historical data analysis server is further coupled to the historical data database, and where the historical data analysis server is further operable to:
solve a logistic regression model based on the bit vectors of user profile information and historical advertisement related activities for the users;
determine, for each user profile of a plurality of user profiles, the inner product of the logistic regression solution and each of the user profiles;
segment the plurality of users into user groups; and
determine an average probability for each of the user groups in accordance with the determined inner products.

17. The system of claim 16, where the advertisement server is further operable to:
determine, by solving a linear programming model based on the determined average probabilities, a distribution for the plurality of ads.

18. The system of claim 17, where the distribution is determined based on a constraint selected from the group comprising a temporal constraint, a geographic constraint, or any combination thereof.

19. The system of claim 11, where the advertisement server is further operable to determine an optimal user group for the ad property.

20. The system of claim 11, where the advertisement server is further operable to limit the maximum delivery of the selected advertisement in a period of time.
